(19) United States
(12) Patent Application Publication
(10) Pub. No.: US 2024/0256317 A1
(43) Pub. Date: Aug. 1, 2024

(54) SYSTEMS AND METHODS FOR BACKEND ARCHITECTURE PROVISIONING AND EMULATION

(71) Applicant: Dell Products L.P., Round Rock, TX (US)

(72) Inventors: Srinivas Giri Raju Gowda, Fremont, CA (US); Shyamkumar T. Iyer, Cedar Park, TX (US); Gaurav Chawla, Austin, TX (US)

(21) Appl. No.: 18/160,142

(22) Filed: Jan. 26, 2023

(51) Int. Cl. G06F 9/455

(52) U.S. Cl. CPC G06F 9/45558; G06F 9/5077; G06F 2009/45562

(57) ABSTRACT

A method for executing a process in an enclave virtual machine, the method that includes receiving, by a primary virtual machine, a process request specifying a process, making a determination that the primary virtual machine is not configured to execute the process, and based on the determination, sending the process request to an enclave virtual machine, where the enclave virtual machine is configured to execute the process, and initiating execution of the process on the enclave virtual machine.

### BACKGROUND

Devices are often capable of performing certain functionalities that other devices are not configured to perform, or are not capable of performing. In such scenarios, it may be desirable to adapt one or more systems to enhance the functionalities of devices that cannot perform those functionalities.

### BRIEF DESCRIPTION OF DRAWINGS

FIG. 1A shows a diagram of a system, in accordance with one or more embodiments.

FIG. 1B shows a diagram of a resource database, in accordance with one or more embodiments.

FIG. 1C shows a diagram of a process request, in accordance with one or more embodiments.

FIG. 1D shows a diagram of enclave memory, in accordance with one or more embodiments.

FIG. 2A shows a flowchart of a method for utilizing an enclave virtual machine, in accordance with one or more embodiments.

FIG. 2B shows a flowchart of a method for creating an enclave virtual machine, in accordance with one or more embodiments.

FIG. 2C shows a flowchart of a method for configuring an enclave virtual machine, in accordance with one or more embodiments.

FIG. 2D shows a flowchart of a method for executing a process in an enclave virtual machine, in accordance with one or more embodiments.

FIG. 3 shows an example of a system performing a method for utilizing an enclave virtual machine, in accordance with one or more embodiments.

### DETAILED DESCRIPTION

### General Notes

As it is impracticable to disclose every conceivable embodiment of the described technology, the figures, examples, and description provided herein disclose only a limited number of potential embodiments. One of ordinary skill in the art would appreciate that any number of potential variations or modifications may be made to the explicitly disclosed embodiments, and that such alternative embodiments remain within the scope of the broader technology. Accordingly, the scope should be limited only by the attached claims. Further, certain technical details, known to those of ordinary skill in the art, may be omitted for brevity and to avoid cluttering the description of the novel aspects.

For further brevity, descriptions of similarly-named components may be omitted if a description of that similarly-named component exists elsewhere in the application. Accordingly, any component described with regard to a specific figure may be equivalent to one or more similarly-named components shown or described in any other figure, and each component incorporates the description of every similarly-named component provided in the application (unless explicitly noted otherwise). A description of any component is to be interpreted as an optional embodiment-which may be implemented in addition to, in conjunction with, or in place of an embodiment of a similarly-named component described for any other figure.

### Lexicographical Notes

As used herein, adjective ordinal numbers (e.g., first, second, third, etc.) are used to distinguish between elements and do not create any particular ordering of the elements. As an example, a “first element” is distinct from a “second element”, but the “first element” may come after (or before) the “second element” in an ordering of elements. Accordingly, an order of elements exists only if ordered terminology is expressly provided (e.g., “before”, “between”, “after”, etc.) or a type of “order” is expressly provided (e.g., “chronological”, “alphabetical”, “by size”, etc.). Further, use of ordinal numbers does not preclude the existence of other elements. As an example, a “table with a first leg and a second leg” is any table with two or more legs (e.g., two legs, five legs, thirteen legs, etc.). A maximum quantity of elements exists only if express language is used to limit the upper bound (e.g., “two or fewer”, “exactly five”, “nine to twenty”, etc.). Similarly, singular use of an ordinal number does not imply the existence of another element. As an example, a “first threshold” may be the only threshold and therefore does not necessitate the existence of a “second threshold”.

As used herein, the word “data” is used as an “uncountable” singular noun—not as the plural form of the singular noun “datum”. Accordingly, throughout the application, “data” is generally paired with a singular verb (e.g., “the data is modified”). However, “data” is not redefined to mean a single bit of digital information. Rather, as used herein, “data” means any one or more bit(s) of digital information that are grouped together (physically or logically). Further, “data” may be used as a plural noun if context provides the existence of multiple “data” (e.g., “the two data are combined”).

As used herein, the term “operative connection” (or “operatively connected”) means the direct or indirect connection between devices that allows for interaction in some way (e.g., via the exchange of information). For example, the phrase ‘operatively connected’ may refer to a direct connection (e.g., a direct wired or wireless connection between devices) or an indirect connection (e.g., multiple wired and/or wireless connections between any number of other devices connecting the operatively connected devices).

### Overview and Advantages

In general, this application discloses one or more embodiments of systems and methods for executing processes on an enclave virtual machine. In one or more embodiments, an enclave virtual machine is created to supplement the functionality of an existing primary virtual machine that may be incapable of directly executing a given process. Therefore, an enclave virtual machine may be created and terminated, as needed, to execute specialized tasks and further offload resource utilization, from a primary virtual machine, to other hardware.

In conventional systems, a virtual machine may be requested to execute a workload (e.g., execute a process) that requires resources the virtual machine lacks. As an example, a virtual machine with an x86 virtual processor may receive a request to execute a workload requiring an ARM processor. However, the virtual machine will be unable to execute the requested operations as the requested processor architecture is not supported by the virtual machine.

In such situations, an imperfect solution may provide the virtual machine with physical/virtual resource functions to access the required underlying hardware. Yet, this imperfect solution introduces multiple issues. First, highly-customized libraries, code, and configurations may be utilized which do not easily integrate with resource functions. Thus, time and energy must be expended to modify existing software to allow for integration. Further, the reliance on external protocols to other machines can expose protected data (e.g., requiring normally-encrypted data to be sent in-the-clear to an external device for processing).

Accordingly, as discussed in one or more embodiments herein, a primary virtual machine may initiate the creation of an enclave virtual machine to provide capabilities not supported by the primary virtual machine. Continuing with the example above, if an x86-based primary virtual machine receives a request to execute a process that requires an ARM-based processor, that primary virtual machine can create an enclave virtual machine, with ARM support, to execute the requested task. Further, such systems and methods described herein allow for the secure creation of, communication with, and processing of data on enclave virtual machines.

Further, the ability to create additional virtual machines allows for (i) increased flexibility in the allocation of resources, (ii) specific and tailored customization of virtual machines, and (iii) the ability to offload inefficient tasks to better-configured virtual machines. And, such processes may be configured to occur automatically “in the background”, thereby reducing complexity for a user that may manually manage virtual machines.

The following sections describes figures which are directed to various non-limiting embodiments.

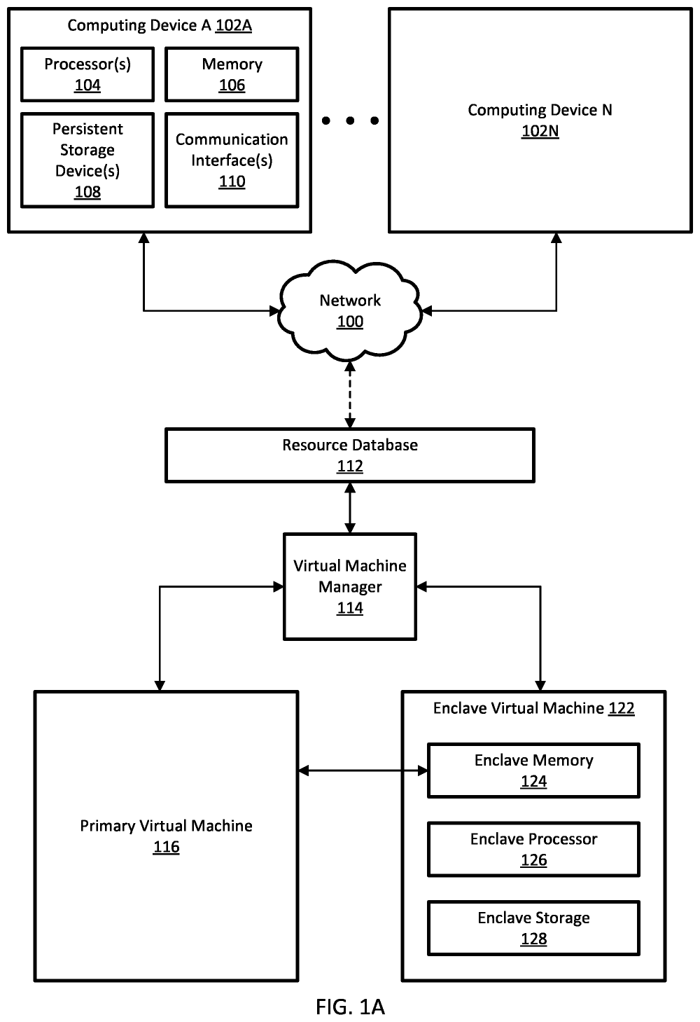

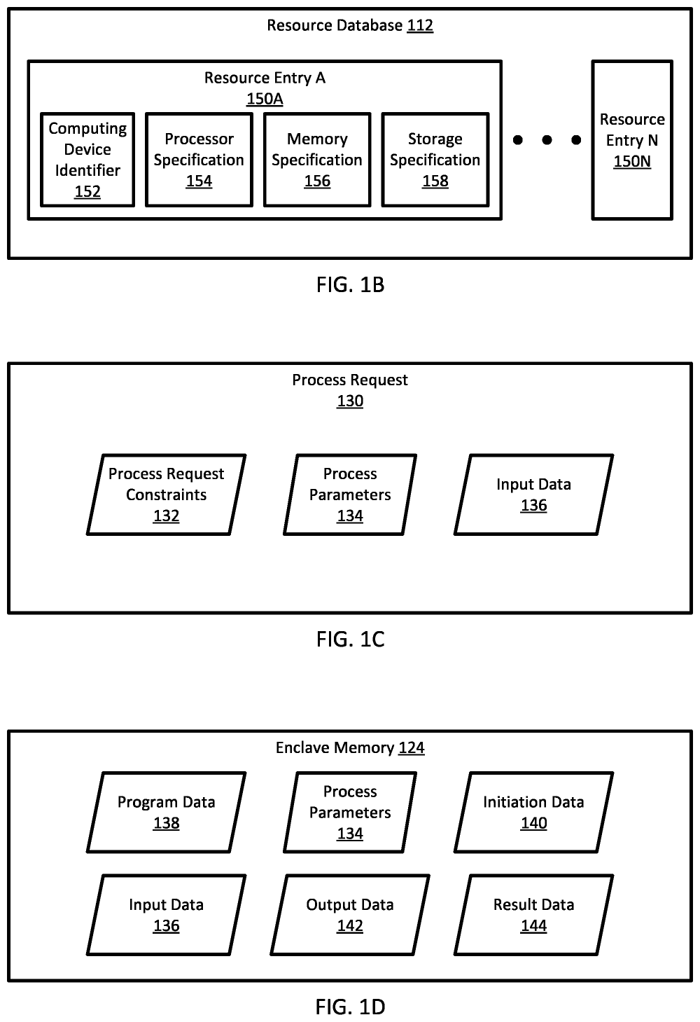

### FIG. 1A

FIG. 1A shows a diagram of a system, in accordance with one or more embodiments. In one or more embodiments, a system may include one or more computing device(s) (102), a network (100), resource database (112), a virtual machine manager (114), a primary virtual machine (116), and an enclave virtual machine (122). Each of these components is described below.

In one or more embodiments, a network (e.g., network (100)) is a collection of connected network devices (not shown) that allow for the communication of data from one network device to other network devices, or the sharing of resources among network devices. Non-limiting examples of a network (e.g., network (100)) include a local area network (LAN), a wide area network (WAN) (e.g., the Internet), a mobile network, any combination thereof, or any other type of network that allows for the communication of data and sharing of resources among network devices and/or computing devices (102) operatively connected to the network (100). One of ordinary skill in the art, having the benefit of this detailed description, would appreciate that a network is a collection of operatively connected computing devices that enables communication between those computing devices.

In one or more embodiments, a computing device (e.g., computing device A (102A), computing device N (102N)) is hardware that includes any one, or combination, of the following components:
(i) processor(s) (104),
(ii) memory (106) (volatile and/or non-volatile),
(iii) persistent storage device(s) (108),
(iv) communication interface(s) (110) (e.g., network ports, small form-factor pluggable (SFP) ports, wireless network devices, etc.),
(v) internal physical interface(s) (e.g., serial advanced technology attachment (SATA) ports, peripheral component interconnect (PCI) ports, PCI express (PCIe) ports, next generation form factor (NGFF) ports, M.2 ports, etc.),
(vi) external physical interface(s) (e.g., universal serial bus (USB) ports, recommended standard (RS) serial ports, audio/visual ports, etc.),
(vii) input and output device(s) (e.g., mouse, keyboard, monitor, other human interface devices, compact disc (CD) drive, other non-transitory computer readable medium (CRM) drives), and/or
(viii) peripheral device(s) operatively connected to internal and/or external physical interface(s) (e.g., graphics processing unit (GPU), data processing unit (DPU), sound card, audio/video capture card, etc.).

Non-limiting examples of a computing device (102) include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of computing device (102) with the aforementioned capabilities. In one or more embodiments, a computing device (102) may be operatively connected to another computing device (102) via a network (100).

In one or more embodiments, a processor (104) is an integrated circuit for processing computer instructions. In one or more embodiments, persistent storage device(s) (108) (and/or memory (106)) may store software that is executed by the processor(s) (104). A processor (104) may be one or more processor cores or processor micro-cores.

In one or more embodiments, memory (106) is one or more hardware devices capable of storing digital information (e.g., data) in a non-transitory medium. In one or more embodiments, when accessing memory (106), software may be capable of reading and writing data at the smallest units of data normally accessible (e.g., “bytes”). Specifically, in one or more embodiments, memory (106) may include a unique physical address for each byte stored thereon, thereby enabling software to access and manipulate data stored in memory (106) by directing commands to a physical address of memory that is associated with a byte of data (e.g., via a virtual-to-physical address mapping). Non-limiting examples of memory (106) devices include flash memory, random access memory (RAM), dynamic RAM (DRAM), static RAM (SRAM), and resistive RAM (ReRAM). In one or more embodiments, memory (106) may be volatile or non-volatile.

In one or more embodiments, a persistent storage device (108) (i.e., “storage”) is one or more hardware devices capable of storing digital information (e.g., data) in a non-transitory medium. Non-limiting examples of a persistent storage device (108) include integrated circuit storage devices (e.g., solid-state drive (SSD), Non-Volatile Memory Express (NVMe), flash memory, etc.), magnetic storage (e.g., hard disk drive (HDD), floppy disk, tape, diskette, etc.), and optical media (e.g., compact disc (CD), digital versatile disc (DVD), etc.). In one or more embodiments, prior to reading and/or manipulating data located on a persistent storage device (108), data may first be required to be copied in “blocks” (instead of “bytes”) to other, intermediary storage mediums (e.g., memory) where the data can then be accessed in “bytes”.

In one or more embodiments, a communication interface (110) is a hardware component that provides capabilities to interface a computing device (102) with one or more other computing device(s) (102) (e.g., through a network (100) to another computing device (102), another server, a network of devices, etc.) and allow for the transmission and receipt of data with those devices. A communication interface may communicate via any suitable form of wired interface (e.g., Ethernet, fiber optic, serial communication etc.) and/or wireless interface and utilize one or more protocols for the transmission and receipt of data (e.g., transmission control protocol (TCP)/internet protocol (IP), remote direct memory access (RDMA), Institute of Electrical and Electronics Engineers (IEEE) 801.11, etc.).

As used herein, “software” means any set of instructions, code, and/or algorithms that are used by a computing device (102) to perform one or more specific task(s), function(s), or process(es). A computing device (102) may execute software (e.g., via processor(s) (104) and memory (106)) which read and write data stored on one or more persistent storage device(s) (108) and/or memory device(s) (106). Software may utilize resources from one or more computing device(s) (102) simultaneously and may move between computing devices (102), as commanded (e.g., via network (100)). Additionally, multiple software instances may execute on a single computing device (102) simultaneously.

In one or more embodiments, a computing resource is any one of the components, or subcomponents, of a computing device (102). Computing resources may be allocated to software (e.g., virtual machines (116)) for use by that software. Non-limiting examples of a computing resource include a processor (104), a processor core, a processor thread, any range of memory (106), any block(s) on a persistent storage (108) device, and any peripheral device components or sub-components (e.g., a GPU, a portion of processing time on a GPU, etc.).

In one or more embodiments, a resource database (112) is a data structure which includes information about the computing resources (e.g., processor(s) (104), memory (106), and persistent storage device(s) (108)) in one or more computing device(s) (102). Additional details regarding the resource database (112) may be found in the description of FIG. 1B.

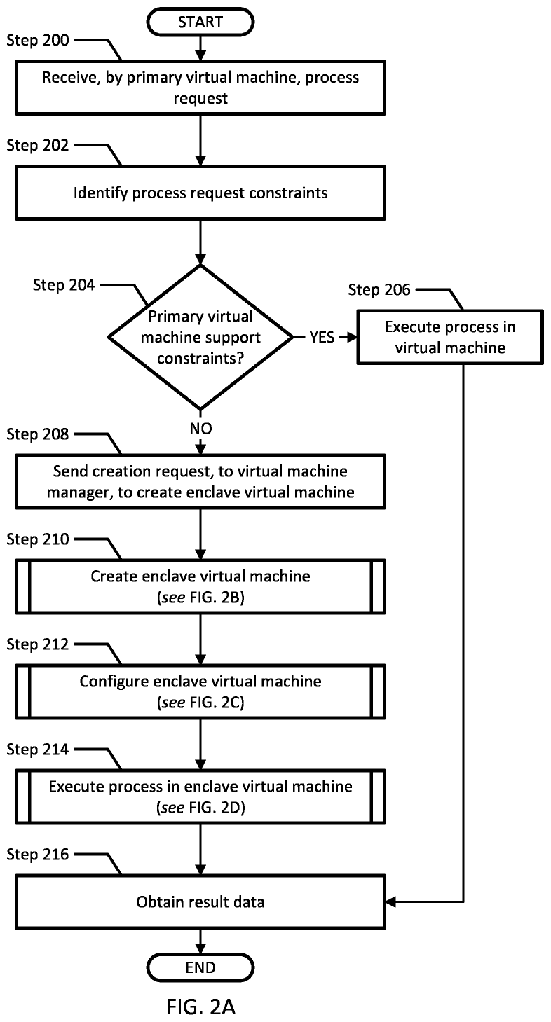

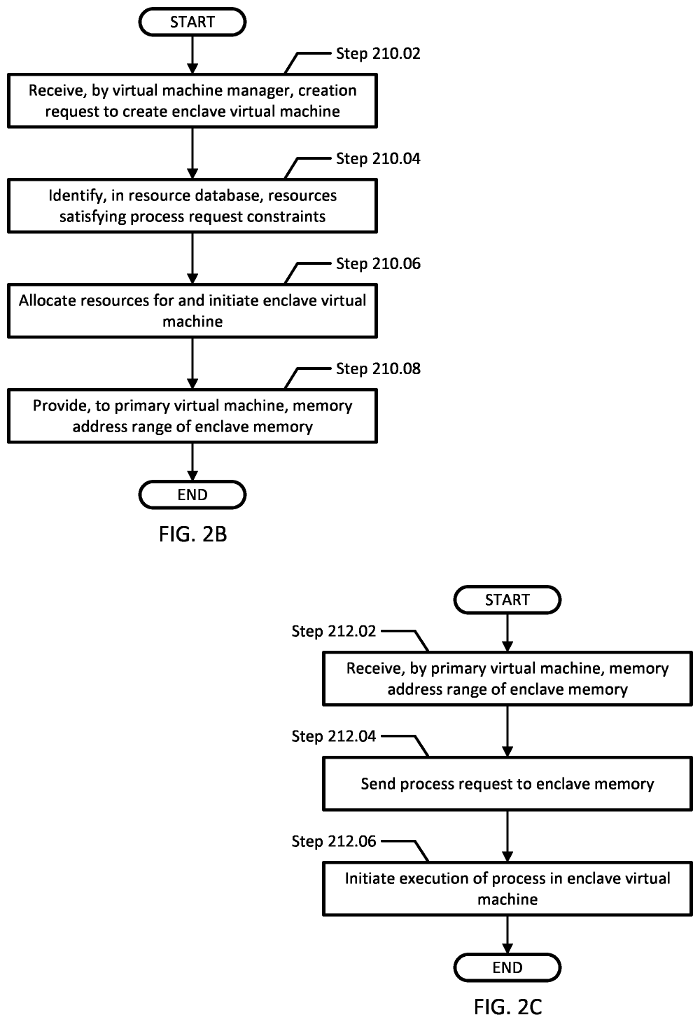

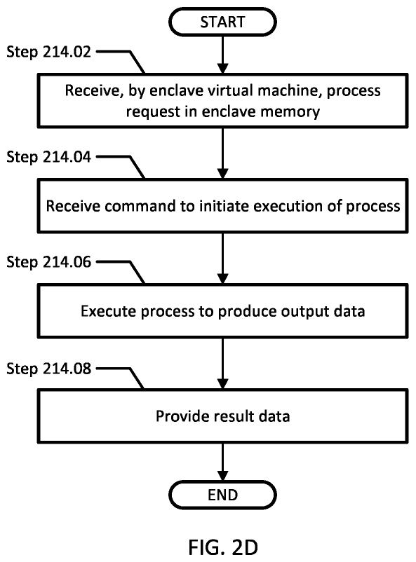

In one or more embodiments, a virtual machine manager (114) is software, executing on a computing device, which manages (e.g., creates, generates, initiates, scales, terminates, etc.) virtual machines. A virtual machine manager (114) may use the resource database (112) to identify, locate, and allocate resources of one or more computing device(s) (102) to virtual machines. Additional details regarding the functions of the virtual machine manager (114) may be found in the description of FIGS. 2A-D.

In one or more embodiments, a virtual machine (e.g., primary virtual machine (116), enclave virtual machine (122)) is software, executing on one or more computing device(s) (102), that provides a virtual environment in which other software (e.g., a program, a process) may execute. In one or more embodiments, a virtual machine is created by a virtual machine manager (114) and is allocated computing resources (e.g., processor(s), memory, storage) that are represented as virtual resources, within the virtual machine, and utilized by the software executing therein. Virtual resources may be assigned specifications matching the underlying hardware. As a non-limiting example of a virtual resource, a virtual processor may be designated as having an “x86” architecture if the virtual processor is allocated some portion of a physical processor (104) with an x86 architecture. Virtual resources may be aggregated from one or more computing device(s) (102) and presented as a unified entity to software executing in the virtual machine. As a non-limiting example, a single continuous virtual memory region may correspond to two different physical memory devices (106) physically disposed in two different computing devices (102). Similarly, as another non-limiting example, a virtual machine may provide a virtual processor that corresponds to one or more physical processor(s) (104), only a portion of a single processor (104), and/or two or more portions of two or more processors (104), respectively.

In one or more embodiments, as used herein, a virtual machine (116) may be a “container” that virtualizes only software elements (and does not utilize virtual hardware components). That is, a virtual machine (116) may utilize hardware by executing one or more “calls” to an operating system (not shown) and performing operations as ordinary software. Accordingly, use of the term “virtual machine” herein includes both virtual machines (as they are commonly known) and/or other virtualized/isolated software environments (e.g., “containers”).

In one or more embodiments, a virtual machine (116) supports the smart data accelerator interface (SDXI) protocol for memory-to-memory data transfer. Utilization of the SDXI protocol allows for secure communication over memory channels, including the exposure of virtual resources (e.g., virtual processor(s), virtual memory, virtual storage, virtual peripheral devices) and to securely read, write, and process data using those resources. Further, the SDXI protocol allows for the chaining of multiple virtual machines (116) together to allow for a secure “pipeline” of data processing from one virtual machine to another.

In one or more embodiments, a primary virtual machine (116) is a virtual machine that may be interacted with directly by a user (e.g., a human). A primary virtual machine (116) may provide a single point of interaction for a user of the system (i.e., not having to interact with multiple virtual machines) thereby reducing the complexity of interaction and management with the system. In one or more embodiments, a primary virtual machine (116) may be configured to initiate the creation of one or more enclave virtual machine(s) (122) by sending a creation request to the virtual machine manager (114) to create a new enclave virtual machine (122) (with specified resource specifications). Additional details regarding the functions of the primary virtual machine (116) may be found in the description of FIGS. 2A-D.

In one or more embodiments, an enclave virtual machine (122) is a virtual machine. An enclave virtual machine (122) may be created to provide additional functionality (e.g., provide different resource specifications) to a primary virtual machine (116). In one or more embodiments, an enclave virtual machine (122) is generated by the virtual machine manager (114) upon the request of the primary virtual machine (116). Additional details regarding the functions of an enclave virtual machine (122) may be found in the description of FIGS. 2A-D.

In one or more embodiments, enclave memory (124) is a region of virtual memory in the enclave virtual machine (122). Enclave memory (124) may be “shared” memory that is equally accessible by the primary virtual machine (116) and the enclave virtual machine (122). In one or more embodiments, the enclave memory (124) acts as a means for communication and data transfer between the primary virtual machine (116) and the enclave virtual machine (122). The memory channel established for the primary virtual machine (116) to access the enclave memory (124) may be “secure” (i.e., encrypted) thereby ensuring no data is transmitted “in-the-clear” between the virtual machines. In one or more embodiments, the memory channel is established using the SDXI protocol thereby allowing for a commonly-understood protocol when utilizing shared memory (e.g., enclave memory (124)). Additional details regarding some data that may be stored in enclave memory (124) may be found in the description of FIG. 1D.

In one or more embodiments, an enclave processor (126) is a virtual processor used to execute software in the enclave virtual machine (122). The enclave processor (126) may be designated with a processor specification (154) that matches the allocated underlying hardware (e.g., “x86”, “ARM”, “2 cores”, “8 threads”, etc.).

In one or more embodiments, enclave storage (128) is virtual storage that is used by the enclave virtual machine (122) to store data that is not needed and/or too large to store in enclave memory (124). As a non-limiting example, if the output data (142) generated (e.g., 2 TB) is larger than the enclave memory (124) (e.g., 8 GB), the enclave virtual machine (122) may store output data (142) in the enclave storage (128) as the output data (142) is generated to free up the enclave memory (124).

While a specific configuration of a system is shown, other configurations may be used without departing from the disclosed embodiment. Accordingly, embodiments disclosed herein should not be limited to the configuration of devices and/or components shown.

### FIG. 1B

FIG. 1B shows a diagram of a resource database, in accordance with one or more embodiments. In one or more embodiments, a resource database (112) is a data structure that includes one or resource entries (e.g., resource entry A (150A), resource entry N (150N)). In one or more embodiments, a resource entry (150) is a data structure that may include (or otherwise be associated with):
(i) a computing device identifier (152) that uniquely identifies a single computing device associated with the resource entry (150) (non-limiting examples of an identifier include a tag, an alphanumeric entry, a filename, and a row number in table),
(ii) a processor specification (154) that provides information about one or more processor(s) in the associated computing device (102). In one or more embodiments, a processor specification (154) may specify one or more properties of the processor(s), including the architecture (e.g., x86, ARM, etc.), the manufacturer/model, core count, thread count, clock speed(s), cache size, memory channels, and/or any other information about processor(s) (104) in a specific computing device (102),
(iii) a memory specification (156) that provides information about one or more memory device(s) (106) in the associated computing device (102). In one or more embodiments, a memory specification (156) may specify one or more properties of the memory device(s) (106), including the capacity (e.g., 4 GB, 32 GB, etc.), clock frequency, cell type (e.g., DRAM, SRAM, etc.), and/or any other information about the memory device(s) (106) in a specific computing device (102),
(iv) a storage specification (158) that provides information about one or more persistent storage device(s) (108) in the associated computing device. In one or more embodiments, a storage specification (158) may specify one or more properties of the persistent storage device(s) (108), including the capacity (e.g., 512 GB, 12 TB, etc.), type (e.g., magnetic disk, solid state), read/write speed, speed spin (if applicable), and/or any other information about the persistent storage device(s) (108) in a specific computing device (102), and/or
(v) any combination thereof.

While a specific configuration of a resource database is shown, other configurations may be used without departing from the disclosed embodiment. Accordingly, embodiments disclosed herein should not be limited to the configuration of devices and/or components shown.

### FIG. 1C

FIG. 1C shows a diagram of a process request, in accordance with one or more embodiments. In one or more embodiments, a process request (130) is a data structure that may include process request constraints (132), process parameters (134), and input data (136). Each of these components is described below.

In one or more embodiments, process request constraints (132) is a data structure that includes information relating the requirements to execute a process (e.g., the process described by the process parameters (134)). Process request constraints (132) may include parts of a processor specification (154) and parts of a memory specification (156). As a non-limiting example, process request constraints (132) may specify that, in order to execute the process, the host machine requires (i) an ARM processor architecture, (ii) a minimum of 1 GHz processor clock speed, and (iii) a minimum of 4 GB of memory,
In one or more embodiments, process parameters (134) is a data structure that includes information about what process is to be executed (i.e., the software to use and the task perform), the location of the input data (136), and if applicable, any options for that process (i.e., custom configuration of the process). As a non-limiting example, process parameters (134) may specify the program “zip.exe”, a “compression” task, with the option to use compression level of “5”. As another non-limiting example, process parameters (134) may specify the software package “crypt”, the process “encrypt”, and the option to use advanced encryption standard (AES)-128 encryption standard.

In one or more embodiments, input data (136) is a data that is to be used and/or manipulated by a process (e.g., the process described by the process parameters (134)) to produce output data (142). Input data (142) may be any data (e.g., banking transactions, medical information, literary works, video data, raw data gathered from sensors, etc.). In one or more embodiments, input data (136) may include the location of other data on which the process is to be executed (e.g., the input data (136) includes the address/filename of data located in storage, where that other data is then used (by the process) to produce output data (142)).

While a specific configuration of a process request is shown, other configurations may be used without departing from the disclosed embodiment. Accordingly, embodiments disclosed herein should not be limited to the configuration of devices and/or components shown.

### FIG. 1D

FIG. 1D shows a diagram of enclave memory, in accordance with one or more embodiments. In one or more embodiments, enclave memory (124) is a data structure that may include program data (138), process parameters (134), initiation data (140), input data (136), and output data (142). Previously undiscussed components are described below.

In one or more embodiments, program data (138) is a data structure that includes the underlying data to execute the program. In one or more embodiments, the program data (138) includes the necessary files (e.g., executable files, dynamic-link libraries, program packages, etc.) needed to execute the process specified in the process parameters (134).

In one or more embodiments, initiation data (140) is a data structure that includes an indicator (e.g., a flag, a set bit, any binary information) to instruct the enclave virtual machine (122) to begin the process specified in the process parameters (134). In one or more embodiments, the initiation data (142) is written by the primary virtual machine (116) to initiate the process and may be used to control the order of the processing of the input data (136)—to ensure the input data (136), program data (138), and process parameters (134) are successfully written to the enclave memory (124) prior to executing the process. In one or more embodiments, the initiation data (142) may further include metadata regarding the memory address of the program data (138), process parameters (134), and input data (136) in the enclave memory (124) and/or enclave storage (128).

In one or more embodiments, output data (142) is a data structure that includes the data as modified by a process (e.g., the process specified in the process parameters (134)). As a non-limiting example, if the process was to “compress” the input data (136), the output data (142) would be the compressed data—as generated by the compression process. As another non-limiting example, if the input data (136) was encrypted customer information, and the process was to decrypt and extract the names and email addresses of customers, the output data (142) would be a file (or file(s)) containing the names and email addresses of customers. As the input data (136) can be any possible data, and the process can be any possible process, one of ordinary skill in the part, provided the benefit of this detailed description, would appreciate that the output data (142) could be any data generated from processing the input data (136).

In one or more embodiments, result data (144) is a data structure that includes information about the final status of the process and/or the output data (142). In one or more embodiments, the result data (144) may be (i) a message indicating the success or failure of the process (e.g., “complete”, “failed”, “error”, etc.), (ii) the location of the output data (142) (e.g., the memory address in enclave memory (124), the location in enclave storage (128), etc.), and/or (iii) the output data (142) itself.

While a specific configuration of enclave memory is shown, other configurations may be used without departing from the disclosed embodiment. Accordingly, embodiments disclosed herein should not be limited to the configuration of devices and/or components shown.

### FIG. 2A

FIG. 2A shows a flowchart of a method for utilizing an enclave virtual machine, in accordance with one or more embodiments. All or a portion of the method shown may be performed by one or more components of the system (e.g., the primary virtual machine, the enclave virtual machine, and the virtual machine manager). However, another component of the system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 200, the primary virtual machine receives a process request. In one or more embodiments, the primary virtual machine receives the process request from a user of the primary virtual machine and/or from some other software operating on any computing device of the system. As discussed in the description of FIG. 1B, the process request may include (i) process request constraints, (ii) process parameters, and (iii) input data. The process request may be written to the virtual memory of the primary virtual machine.

In Step 202, the primary virtual machine identifies the process request constraints from the process request.

In Step 204, the primary virtual machine makes a determination if the virtual components (processor(s), memory, storage) allocated to the primary virtual machine (itself) satisfy the requirements of the process request constraints. To make this determination, the primary virtual machine performs a lookup of the specifications for its own allocated virtual components and compares those specifications against the process request constraints.

If the primary virtual machine supports all of the process request constraints (Step 204-YES), the method proceeds to Step 206. However, if the virtual machine does not support any one of the process request constraints (Step 204-NO), the method proceeds to Step 208.

In Step 206, the primary virtual machine executes the process specified in the process request. As determined in Step 204, the virtual components allocated to the primary virtual machine met the requirements of the process request and therefore the process is capable of execution on the primary virtual machine. In such instances, the primary virtual machine executes the process, as requested.

In Step 208, the primary virtual machine sends a creation request to the virtual machine manager to create an enclave virtual machine that satisfies the process request constraints (the creation request may include the process request constraints). As a non-limiting example, if the process request constraints specify (i) an x86 architecture and (ii) 2 GB of available memory, the primary virtual machine specifies those minimum requirements (e.g., an x86 processor and 2 GB of memory) to the virtual machine manager in the creation request.

In Step 210, the virtual machine manager creates an enclave virtual machine satisfying the process request constraints, in order to execute the process specified in the process request. Additional details regarding this step may be found in the description of FIG. 2B.

In Step 212, the primary virtual machine configures the enclave virtual machine to execute the process specified in the process request. Additional details regarding this step may be found in the description of FIG. 2C.

In Step 214, the enclave virtual machine executes the process specified in the process request. Additional details regarding this step may be found in the description of FIG. 2D.

In Step 216, the primary virtual machine obtains the result data. In one or more embodiments, the enclave virtual machine sends (or otherwise makes available) the result data to the primary virtual machine after completing the execution of the process specified in the process request.

### FIG. 2B

FIG. 2B shows a flowchart of a method for creating an enclave virtual machine, in accordance with one or more embodiments. All or a portion of the method shown may be performed by one or more components of the system (e.g., the virtual machine, virtual machine manager, and enclave virtual machine). However, another component of the system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 210.02, the virtual machine manager receives a creation request from a primary virtual machine. As discussed in the description of Step 208, the creation request may specify minimum virtual resources to allocate to the enclave virtual machine in order to satisfy the process request constraints. Accordingly, an enclave virtual machine generated therefrom can be created to execute the process specified in the process request.

In Step 210.04, the virtual machine manager identifies available computing resources, via the resource database, which satisfy the requirements specified in the creation request. In one or more embodiments, the virtual machine manager performs a lookup of the relevant specifications, in the resource database, to find resource entries matching, satisfying, or exceeding one or more of the specified requirements.

In Step 210.06, the virtual machine manager allocates the required resources for the enclave virtual machine and initiates the enclave virtual machine using those resources. The allocated resources may include (i) an enclave processor mapped to one or more processor(s) of one or more computing device(s) and (ii) enclave memory mapped to one or more memory device(s) of a computing device. In one or more embodiments, (iii) enclave storage may also be allocated, which is mapped to the storage device(s) of one or more computing device(s). After allocating the resources for the enclave virtual machine, the virtual machine manager initiates execution of the enclave virtual machine by ‘booting up’ the virtual machine for future processing.

In Step 210.08, the virtual machine manager sends the memory address range of the enclave memory to the primary virtual machine. In one or more embodiments, the virtual machine manager sends the memory address range to the primary virtual machine so that the primary virtual machine may communicate with the enclave virtual machine (e.g., via the exchange of data in the enclave memory).

### FIG. 2C

FIG. 2C shows a flowchart of a method for configuring an enclave virtual machine, in accordance with one or more embodiments. All or a portion of the method shown may be performed by one or more components of the system (e.g., the virtual machine, virtual machine manager, and enclave virtual machine). However, another component of the system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 212.02, the virtual machine receives the memory address range of the enclave memory from the virtual machine manager. In one or more embodiments, the memory address range may be a range of virtual or physical memory addresses (e.g., an offset and length) to which the primary virtual machine may directly read and write data.

In Step 212.04, the virtual machine writes all (or part) of the process request and the program data to the enclave memory. In one or more embodiments, the primary virtual machine writes the program data, process parameters, and input data to specially designated portions of the enclave memory (e.g., regions where the enclave virtual machine is configured to read that data).

In Step 212.06, the virtual machine initiates execution of the process in the enclave virtual machine. In one or more embodiments, the primary virtual machine initiates execution of the process in the enclave virtual machine by writing initiation data to the enclave memory (e.g., writing a “1” bit, “start”, “run”, etc.).

### FIG. 2D

FIG. 2D shows a flowchart of a method for executing a process in an enclave virtual machine, in accordance with one or more embodiments. All or a portion of the method shown may be performed by one or more components of the system (e.g., the virtual machine, virtual machine manager, and enclave virtual machine). However, another component of the system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 214.02, the enclave virtual machine receives all (or a part) of the process request and the program data in the enclave memory. In one or more embodiments, the enclave virtual machine receives the program data, process parameters, and input data. The data sent to the enclave virtual machine may be provided by an external entity (i.e., the primary virtual machine) writing the data to designated regions of the enclave memory. In one or more embodiments, the enclave virtual machine does not begin to initiate the process until initiation data is received.

In Step 214.04, the enclave virtual machine receives a command to begin executing the process. In one or more embodiments, the command to begin executing the process is provided by an external entity (i.e., the primary virtual machine). The command to begin executing the process may be received as initiation data written to a designated region of the enclave memory. Accordingly, in one or more embodiments, the enclave virtual machine may periodically check a region of the enclave memory designated for initiation data and, when detected, begin executing the process.

In Step 214.06, the enclave virtual machine executes the process specified in the enclave memory. In one or more embodiments, the enclave virtual machine executes the process using the program data to modify the input data as specified by the process parameters to produce the output data. As the virtual components allocated to the enclave virtual machine necessarily satisfy the requirements of the process request, the process is therefore capable of execution on the enclave virtual machine.

In Step 214.08, the enclave virtual machine provides the result data. In one or more embodiments, upon finishing the execution of the process, the enclave virtual machine may generate result data and send that result data to the primary virtual machine (or another external entity), write the result data to enclave memory, write the result data to enclave storage, and/or otherwise make the result data available to any entity with proper access.

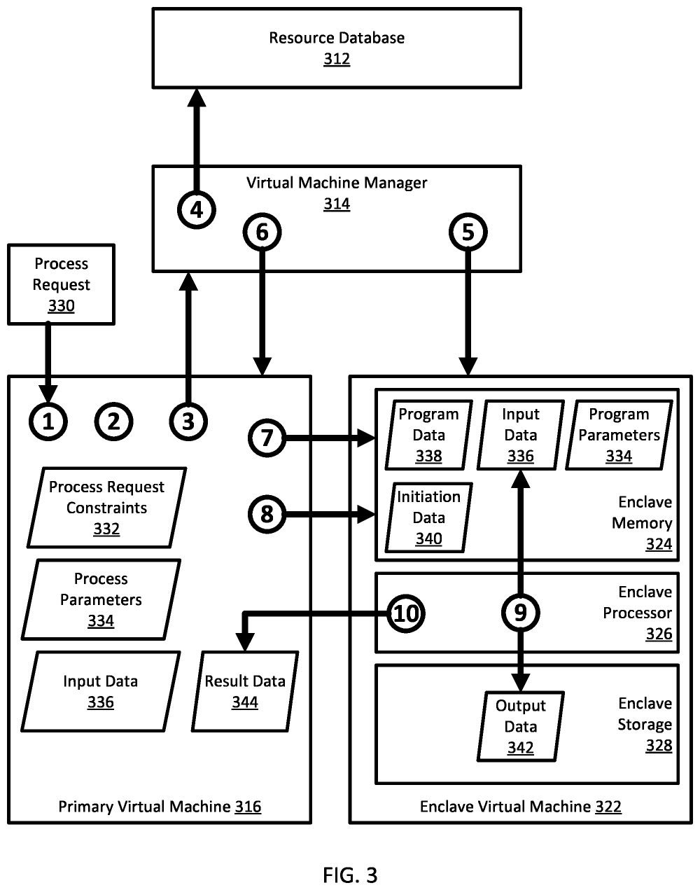

### FIG. 3

FIG. 3 shows an example of a system performing a method for utilizing an enclave virtual machine, in accordance with one or more embodiments. The example is not intended to limit the scope of the technology.

Consider a scenario where, at (1), a primary virtual machine (316) receives a process request (330) written in the virtual memory of the primary virtual machine (316). The process request (330) includes (i) process request constraints (332), (ii) process parameters (334), and (iii) input data (336). Specifically, the process request constraints (332) specify that an “ARM” processor architecture is needed to execute the requested process. The process parameters (334) specify a “compression” process at level “2” using the “zip” package. And, the input data (336) is 800 GB of image data.

At (2), the primary virtual machine (316) makes a determination that the virtual processor allocated to the primary virtual machine (316) is an “x86” processor architecture and is therefore not capable of executing the requested process. Accordingly, at (3), the primary virtual machine (316) sends a creation request to the virtual machine manager (314) to create an enclave virtual machine (322) that supports an ARM architecture processor. Further, the creation request includes a memory specification of, at least, 8 GB and a storage minimum of 2 TB.

At (4), the virtual machine manager (314) analyzes the resource database (312) and identifies a first computing device (not shown) with an ARM architecture processor which also includes 12 GB of free memory. However, the computing device only has 500 GB of free storage. Accordingly, the virtual machine manager (314) identifies a second computing device (not shown) with 1.5 TB of free storage-enough to satisfy the remaining resource minimums.

Once identified, at (5), the virtual machine manager (314) allocates the aforementioned resources to the enclave virtual machine (322) as virtual resources, and initiates (e.g., boots up) the enclave virtual machine (322). Once booted up, the enclave virtual machine (322) includes (i) 8 GB of enclave memory (324) mapped to the 8 GB (of the free 12 GB) of the first computing device, (ii) an enclave processor (326) mapped to the ARM processor of the first computing device, and (iii) 2 TB of enclave storage (328) mapped to 500 GB of the first computing device and 1.5 TB of the second computing device (not shown).

At (6), the virtual machine manager (314) provides the memory address range of the enclave memory (324) to the primary virtual machine (316). In turn, at (7), the primary virtual machine (316) copies the (i) program data (338) (i.e., the “zip” package), (ii) the input data (336) (i.e., the 800 GB of image data), and (iii) the program parameters (334) (i.e., compression level “2”) to the enclave memory (324). However, as the enclave memory is only 8 GB, the enclave virtual machine (322) writes nearly all of the input data (336) to the enclave storage (328) (not shown for simplicity).

At (8), the primary virtual machine (316) sends initiation data (340) (i.e., a “1” bit) to the enclave memory (324) at a designated location. In turn, the enclave virtual machine (322) identifies the existence of the initiation data (340) at the designated location of the enclave memory (324) and begins executing the process. Accordingly, at (9), the enclave virtual machine (322) uses the ARM-based enclave processor (326) to compress the input data (336) to generate output data (342). The enclave virtual machine (322) copies the input data (336) to enclave memory (324) in smaller chunks for processing, as needed from the enclave storage (328). When compressed, the output data (342) has a size of 500 GB and is stored in the enclave storage (328).

Upon completion of the compression process, at (10), the enclave virtual machine (322) sends result data (344) to the primary virtual machine (316). The enclave virtual machine (322) writes the result data (344) to the enclave memory (324), which is then identified by the primary virtual machine (316) and copied to the virtual memory of the primary virtual machine (316). The result data (344) includes a status indicating a “successful” compression of the input data (336) (800 GB of image data) and specifies the location, in the enclave storage (328) where the output data (342) (500 GB of compressed image data) is stored.

What is claimed is:

1. A method for executing a process in an enclave virtual machine, the method comprising:
receiving, by a primary virtual machine, a process request specifying a process;
making a determination that the primary virtual machine is not configured to execute the process; and
based on the determination:
sending the process request to an enclave virtual machine, wherein the enclave virtual machine is configured to execute the process; and
initiating execution of the process on the enclave virtual machine.

2. The method of claim 1, wherein prior to sending the process request to the enclave virtual machine, the method further comprises:
sending a creation request, to a virtual machine manager, to create the enclave virtual machine.

3. The method of claim 2, wherein the primary virtual machine supports a first processor architecture and the enclave virtual machine supports a second processor architecture.

4. The method of claim 3, wherein the process requires the second processor architecture.

5. The method of claim 4, wherein the creation request specifies the second processor architecture for the enclave virtual machine.

6. The method of claim 1, wherein sending the process request to the enclave virtual machine comprises:
writing the process request to enclave memory, wherein the enclave virtual machine comprises the enclave memory.

7. The method of claim 1, wherein after initiating execution of the process on the enclave virtual machine, the method further comprises:
obtaining result data of the process.

8. A non-transitory computer readable medium comprising instructions which, when executed by a processor, enables the processor to perform a method for executing a process in an enclave virtual machine, the method comprising:
receiving, by a primary virtual machine, a process request specifying a process;
making a determination that the primary virtual machine is not configured to execute the process; and
based on the determination:
sending the process request to an enclave virtual machine, wherein the enclave virtual machine is configured to execute the process; and
initiating execution of the process on the enclave virtual machine.

9. The non-transitory computer readable medium of claim 8, wherein prior to sending the process request to the enclave virtual machine, the method further comprises:
sending a creation request, to a virtual machine manager, to create the enclave virtual machine.

10. The non-transitory computer readable medium of claim 9, wherein the primary virtual machine supports a first processor architecture and the enclave virtual machine supports a second processor architecture.

11. The non-transitory computer readable medium of claim 10, wherein the process requires the second processor architecture.

12. The non-transitory computer readable medium of claim 11, wherein the creation request specifies the second processor architecture for the enclave virtual machine.

13. The non-transitory computer readable medium of claim 8, wherein sending the process request to the enclave virtual machine comprises:
writing the process request to enclave memory, wherein the enclave virtual machine comprises the enclave memory.

14. A computing device, comprising:
a processor; and
memory storing instructions which, when executed by the processor, enables the processor to perform a method for executing a process in an enclave virtual machine, the method comprising:
receiving, by a primary virtual machine, a process request specifying a process;
making a determination that the primary virtual machine is not configured to execute the process; and
based on the determination:
sending the process request to an enclave virtual machine, wherein the enclave virtual machine is configured to execute the process; and
initiating execution of the process on the enclave virtual machine.

15. The computing device of claim 14, wherein prior to sending the process request to the enclave virtual machine, the method further comprises:
sending a creation request, to a virtual machine manager, to create the enclave virtual machine.

16. The computing device of claim 15, wherein the primary virtual machine supports a first processor architecture and the enclave virtual machine supports a second processor architecture.

17. The computing device of claim 16, wherein the process requires the second processor architecture.

18. The computing device of claim 17, wherein the creation request specifies the second processor architecture for the enclave virtual machine.

19. The computing device of claim 14, wherein sending the process request to the enclave virtual machine comprises:
writing the process request to enclave memory, wherein the enclave virtual machine comprises the enclave memory.

20. The computing device of claim 14, wherein after initiating execution of the process on the enclave virtual machine, the method further comprises:
obtaining result data of the process.
